(19) United States
(12) Patent Application Publication
(10) Pub. No.: US 2025/0094408 A1
(43) Pub. Date: Mar. 20, 2025

(54) DIGITAL OBJECT ANALYSIS AND NON-COMPLIANCE REPORTING SYSTEM AND METHOD THEREOF

(71) Applicant: Bridgeforce Data Solutions, LLC, Chadds Ford, PA (US)

(72) Inventors: Joseph Matthew SCARBOROUGH, Kennett Square, PA (US); Michael EISEL, Wilmington, DE (US); Jason COHENFORD, Warwick, RI (US)

(21) Appl. No.: 18/883,877

(22) Filed: Sep. 12, 2024

Related U.S. Application Data
(60) Provisional application No. 63/582,984, filed on Sep. 15, 2023.

(51) Int. Cl. G06F 16/23; G06F 16/25

(52) U.S. Cl. CPC G06F 16/2365; G06F 16/258

(57) ABSTRACT

The present invention relates to a system for analyzing data values within an object to ensure conformance with predefined parameter protocols. The system comprises a computer, a server, and a non-transitory, computer-readable medium. The computer receives multiple data sets from different sources, reformats and maps the data sets, and processes them using error detection algorithms. The system incorporates additional rules based on regulatory guidance, court settlements, and client feedback to verify conformance of data values to specific parameter protocols. These protocols consider interdependencies between data values within a dataset or across multiple datasets. The system identifies and flags nonconformance in data values, generates reports for each dataset, analyzes these reports to identify inconsistencies across all data sets and generates a comprehensive error report highlighting these inconsistencies. This system ensures accurate and standardized data processing, essential for compliance and error detection in fields like credit data reporting and financial data management.

### CROSS-REFERENCE TO RELATED APPLICATIONS

This application claims priority to U.S. Provisional Patent Application No. 63/582,984, filed Sep. 15, 2023, which is incorporated herein by reference in its entirety for all purposes.

### FIELD OF THE INVENTION

This invention generally relates to the field of data analysis and compliance reporting systems, more specifically, to a digital object analysis and non-compliance reporting system. The system analyzes and verifies data across different types, ensuring that all values conform to the established protocols and identify any inconsistencies that may exist between datasets.

### BACKGROUND OF THE INVENTION

Financial institutions and other furnishers of credit data (Data Furnishers) frequently encounter errors in the data they report and the data that returns to them from Credit Reporting Agencies (CRAs) through dispute processes. These errors can stem from various sources, including data entry mistakes, system integration issues, data transformations by Credit Reporting Agencies, and the complexity of the required format for credit data reporting, the Metro 2® Format, and/or errors tied to the automated online form, the Automated Universal Dataform (AUD), used by Data Furnishers and their vendors to request out-of-cycle credit history updates, i.e., a correction to a consumer's CRA file for consideration outside of the regular activity reporting cycle process. The aforementioned errors can lead to incorrect credit reports, which may adversely affect consumers' credit scores and their ability to secure loans and other financial products. Inaccurate credit reporting not only affects consumers but also exposes financial institutions to legal risks and compliance issues. Consumers may dispute incorrect data through the Credit Reporting Agencies, leading to a process called Automated Credit Dispute Verification (ACDV). If disputes are not resolved accurately and promptly, it can result in increased litigation under the FCRA. The increasing volume of FCRA litigation highlights the need for robust error detection and correction mechanisms.

Current error-checking solutions primarily focus on rules-based error detection at the initial data input stage, such as Metro 2, and may include rudimentary checks of the ACDV Response. However, these solutions do not comprehensively connect analyses across data sources and time to fully understand and address errors. While these solutions are useful, they often fall short in addressing errors that occur at multiple stages of the credit reporting process. Moreover, they may not effectively handle complex interdependencies between different data values or adapt to evolving industry standards. Financial data sets often contain interdependent values where the accuracy of one value depends on another. For example, if a loan balance is zero, the corresponding monthly payment should also be zero. Existing systems may not adequately handle such interdependencies, especially those involving interactions of multiple data types, leading to missed errors.

Accordingly, there remains a need to address the aforementioned technical drawbacks in providing an advanced credit data database object analysis and non-compliance reporting system that reduces the risk of litigation and enhances the accuracy and reliability of financial data reporting.

### BRIEF SUMMARY OF THE INVENTION

The first aspect of the present disclosure provides a system for analyzing an object for conformance of values to parameter protocols, and generating an error report for one or more identified inconsistencies in data values. The system includes a computer, a server coupled with the computer and a non-transitory, computer-readable medium communicably connected to the server. The computer receives a first data set, of a first data set type, associated with the object. The first data set originates from a first source. The computer processes the first data set by applying a plurality of error detection algorithms to the first data set, incorporating additional rules based on regulatory guidance, court settlements, and client feedback to verify conformance of the values of the first data set to a first set of predefined parameter protocols. The parameter protocols include rules based on interdependencies between two or more values within the data set, for a specific month of data or across multiple months. The computer identifies and flags nonconformance of one or more of the values of the first data set relative to the first set of predefined parameter protocols and generates a first report indicating nonconformance within the first data set. The computer receives a second data set, of a second data set type, associated with the object. The second data set originates from a second source, external to the first source. The computer reformats and maps the data of the second data set associated with the object. The reformatting and mapping conform to the data formatting and mapping of the first data set. The computer processes the second data set by applying a plurality of error detection algorithms to the second data set to verify conformance of the values of the second data set to a second set of predefined parameter protocols based on interdependencies between two or more of the values within the second data set. The computer identifies and flags nonconformance of one or more of the values of the second data set relative to the second set of predefined parameter protocols and generates a second report indicating nonconformance within the second data set. The computer receives a third data set, of a third data set type, associated with the object. The third data set originates from the first source and received from the second source. The computer reformats and maps the data of the third data set associated with the object. The reformatting and mapping conform to the data formatting and mapping of the first data set. The computer processes the third data set by applying a plurality of error detection algorithms to the third data set to verify conformance of the values of the third data set to a third set of predefined parameter protocols based on interdependencies between two or more of the values within the third data set. The computer identifies and flags nonconformance of one or more of the values of the third data set relative to the second set of predefined parameter protocols and generates a third report indicating nonconformance within the third data set. The computer possibly receives a fourth data set, of a fourth data set type, associated with the object. The fourth data set originates from the first source and received from the second source. The computer reformats and maps the data of the fourth data set associated with the object, the reformatting and mapping conforming to the data formatting and mapping of the first data set. The computer processes the fourth data set by applying a plurality of error detection algorithms to the fourth data set to verify conformance of the values of the fourth data set to a fourth set of predefined parameter protocols based on interdependencies between two or more of the values within the fourth data set. The computer identifies and flags nonconformance of one or more of the values of the fourth data set relative to the third set of predefined parameter protocols and generates a fourth report indicating nonconformance within the fourth data set. The computer receives additional data sets of any or all of the data set types, reformatting and mapping each data set from each respective data set type to conform to the data formatting and mapping of the first data set. The computer identifies and flags nonconformance of one or more of the values for each data set for each respective data set type and generates a report indicating nonconformance for each data set. The computer analyzes the reports from available data sets across all data set types to identify inconsistent data values within one or more of the first, second, third and fourth data set types and generate an error report for one or more identified inconsistencies in the data values.

In an embodiment, the first data set comprises first parameters and a first value for each of the first parameters.

In another embodiment, the first data set comprises Metro 2® data originating from the first source, the second data set comprises ACDV Request data originating from the second source, the third data set comprises ACDV Response data originating from the first source and received from the second source, and the fourth data set comprises AUD data originating from the first source or a vendor providing technology services for a lender.

In yet another embodiment, the first source is a lender, a furnisher, or the vendor providing technology services for the lender, wherein the second source is a Consumer Reporting Agency (CRA), and external to the first source.

In yet another embodiment, the error detection algorithms comprise interdependent parameter protocols that trigger secondary checks based on the results of initial value verifications.

In yet another embodiment, the parameter protocol is applied for the value when another value meets a threshold parameter protocol.

In yet another embodiment, the computer provides detailed error descriptions for identified nonconformances and inconsistencies.

In yet another embodiment, the computer provides corrective action recommendations for select identified nonconformances and inconsistencies.

In yet another embodiment, the database object comprises financial data related to a specific consumer account.

In yet another embodiment, the second data set type, the third data set type, and the potential fourth data set type are formatted according to a standardized ASCII Metro 2® format.

The second aspect of the invention provides a method for analyzing a database object comprising data values for conformance of the values to parameter protocols, and generating an error report for one or more identified inconsistencies in the data values. The method includes receiving, at a computer, over a server coupled with the computer, a first data set associated with the object. The first data set originates from a first source external to the computer. The method includes processing, using a set of software instructions, the first data set by applying a plurality of error detection algorithms to the first data set, incorporating additional rules based on regulatory guidance, court settlements, and client feedback to verify conformance of the values of the first data set to a first set of predefined parameter protocols. The parameter protocols include rules based on interdependencies between two or more values within the data set, for a specific month of data or across multiple months. The method includes identifying and flagging nonconformance of one or more of the values of the first data set relative to the first set of predefined parameter protocols to generate a first report indicating nonconformance within the first data set. The method includes receiving a second data set of a second data set type associated with the object. The second data set type originates from a second source, external to the first source. The method includes processing, using the set of software instructions, the second data set of a second data set type by reformatting and mapping to the first data set type and applying a plurality of error detection algorithms to the second data set to verify conformance of the values of the second data set to a second set of predefined parameter protocols based on interdependencies between two or more of the values within the second data set. The method includes identifying and flagging nonconformance of one or more of the values of the second data set relative to the second set of predefined parameter protocols to generate a second report indicating nonconformance within the second data set. The method includes receiving a third data set of a third data set type associated with the object. The third data set type originates from the first source and is received from the second source. The method includes processing, using the set of software instructions, the third data set of a third data set type by reformatting and mapping to the first data set type and applying a plurality of error detection algorithms to the third data set to verify conformance of the values of the third data set to a third set of predefined parameter protocols based on interdependencies between two or more of the values within the third data set. The method includes identifying and flagging nonconformance of one or more of the values of the third data set relative to the third set of predefined parameter protocols to generate a third report indicating nonconformance within the third data set. The method includes possibly receiving a fourth data set of a fourth data set type associated with the object. The fourth data set type originates from the first source and is received from the second source. The method includes processing, using the set of software instructions, the fourth data set of a fourth data set type by reformatting and mapping to the first data set type and applying a plurality of error detection algorithms to the fourth data set to verify conformance of the values of the fourth data set to the fourth set of predefined parameter protocols based on interdependencies between two or more of the values within the fourth data set. The method includes identifying and flagging nonconformance of one or more of the values of the fourth data set relative to the fourth set of predefined parameter protocols to generate a fourth report indicating nonconformance within the fourth data set. The method includes receiving additional data sets of any or all of the data set types. The method includes reformatting and mapping each data set from each respective data set type to conform to the data formatting and mapping of the first data set. The method includes identifying and flagging nonconformance of one or more of the values for each data set for each respective data set type and generating a report indicating nonconformance for each data set. The method includes analyzing the reports from available data sets across all data set types to identify inconsistent data values within one or more of the first, second, third and fourth data set types. The method includes generating an error report for one or more identified inconsistencies in the data values.

In an embodiment, the first data set comprises Metro 2® data originating from the first source, the second data set comprises ACDV Request data originating from the second source, the third data set comprises ACDV Response data originating from the first source and received from the second source, and the fourth data set comprises AUD data originating from the first source or a vendor providing technology services for a lender.

In another embodiment, the first source is a lender, a furnisher, or a vendor providing technology services for the lender, wherein the second source is a Consumer Reporting Agency (CRA), and external to the first source.

In yet another embodiment, the error detection algorithms comprise interdependent parameter protocols that trigger secondary checks based on the results of initial value verifications.

In yet another embodiment, the parameter protocol is applied for the value when another value meets a threshold parameter protocol.

In yet another embodiment, the method includes providing detailed error descriptions for identified nonconformances and inconsistencies.

In yet another embodiment, the method includes providing corrective action recommendations for select identified nonconformances and inconsistencies.

In yet another embodiment, the object comprises financial data related to a specific consumer account.

In yet another embodiment, the second data set type, the third data set type, and the potential fourth data set type are formatted according to a standardized ASCII Metro 2® format.

The third aspect of the invention provides a non-transitory computer-readable storage medium in a system for analyzing an object comprising data values for conformance of the values to parameter protocols, and generating an error report for one or more identified inconsistencies in the data values, the computer-readable storage medium storing programming instructions that, if executed by a server of the system, are operable to cause the system to perform operations comprising: (i) receiving, at a computer, over a server coupled with the computer, a first data set associated with the object. The first data set originates from a first source external to the computer; (ii) processing, using a set of software instructions, the first data set by applying a plurality of error detection algorithms to the first data set, incorporating additional rules based on regulatory guidance, court settlements, and client feedback to verify conformance of the values of the first data set to a first set of predefined parameter protocols. The parameter protocols include rules based on interdependencies between two or more values within the data set, for a specific month of data or across multiple months; (iii) identifying and flagging nonconformance of one or more of the values of the first data set relative to the first set of predefined parameter protocols to generate a first report indicating nonconformance within the first data set; (iv) receiving a second data set of a second data set type associated with the object. The second data set type originates from a second source, external to the first source; (v) processing, using the set of software instructions, the second data set of a second data set type by reformatting and mapping to the first data set type and applying a plurality of error detection algorithms to the second data set to verify conformance of the values of the second data set to a second set of predefined parameter protocols based on interdependencies between two or more of the values within the second data set; (vi) identifying and flagging nonconformance of one or more of the values of the second data set relative to the second set of predefined parameter protocols to generate a second report indicating nonconformance within the second data set; (vii) receiving a third data set of a third data set type associated with the object. The third data set type originates from the first source and is received from the second source; (viii) processing, using the set of software instructions, the third data set of a third data set type by reformatting and mapping to the first data set type and applying a plurality of error detection algorithms to the third data set to verify conformance of the values of the third data set to a third set of predefined parameter protocols based on interdependencies between two or more of the values within the third data set; (ix) identifying and flagging nonconformance of one or more of the values of the third data set relative to the third set of predefined parameter protocols to generate a third report indicating nonconformance within the third data set; (x) possibly receiving a fourth data set of a fourth data set type associated with the object. The fourth data set type originates from the first source and is received from the second source; (xi) processing, using the set of software instructions, the fourth data set of a fourth data set type by reformatting and mapping to the first data set type and applying a plurality of error detection algorithms to the fourth data set to verify conformance of the values of the fourth data set to the fourth set of predefined parameter protocols based on interdependencies between two or more of the values within the fourth data set; (xii) identifying and flagging nonconformance of one or more of the values of the fourth data set relative to the fourth set of predefined parameter protocols to generate a fourth report indicating nonconformance within the fourth data set; (xiii) receiving additional data sets of any or all of the data set types; (xiv) reformatting and mapping each data set from each respective data set type to conform to the data formatting and mapping of the first data set; (xv) identifying and flagging nonconformance of one or more of the values for each data set for each respective data set type and generating a report indicating nonconformance for each data set; (xvi) analyzing the reports from available data sets across all data set types to identify inconsistent data values within one or more of the first, second, third and fourth data set types; (xvii) generating an error report for one or more identified inconsistencies in the data values.

The present invention provides an advanced system for analyzing an object for conformance of values to parameter protocols. It performs multi-stage error detection by comparing data from various sources, such as initial data submissions, ACDV requests, and ACDV responses. By analyzing interdependencies between data values and employing sophisticated algorithms, the system identifies and flags nonconforming values, generates comprehensive error reports, and suggests corrective actions. The system reduces the risk of litigation, and enhances the accuracy and reliability of financial data reporting. The system is designed to process various data sets originating from multiple sources, applying error detection algorithms to validate data integrity, and incorporating additional rules derived from regulatory guidance, court settlements, and client feedback. By reformatting and mapping data sets to a standardized format, the system identifies and flags nonconformance in data values, generating reports that highlight inconsistencies. This comprehensive approach allows the system to analyze and verify data across different types, ensuring that all values conform to the established protocols and identifying any inconsistencies that may exist between datasets.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

FIG. 1 illustrates a system for analyzing a computer database object comprising data values for conformance of the values to parameter protocols and generating an error report for one or more identified inconsistencies in the data values according to various embodiments of the present disclosure.

FIG. 2A-B illustrates a table that outlines the formatting rules and logic for the “Date of Last Payment” field during the ACDV process according to various embodiments of the present disclosure.

FIG. 3A-B illustrates tables focusing on handling the Date of First Delinquency in the context of ACDV requests and responses, and the corresponding updates for e-OSCAR format changes. according to various embodiments of the present disclosure.

FIG. 4 illustrates a table that compares account information from an ACDV request to an ACDV response, highlighting discrepancies and potential data quality issues according to various embodiments of the present disclosure.

FIG. 5 illustrates a graph of FCRA litigation resulting from errors in financial data according to various embodiments of the present disclosure.

FIG. 6 illustrates a graph of complaint volume by financial product or service according to various embodiments of the present disclosure.

FIG. 7 illustrates a workflow of how the system of FIG. 1 is utilized to reduce errors in the financial files according to various embodiments of the present disclosure.

FIG. 8 illustrates a table presenting examples of the values in the object being changed between a ACDV request and a ACDV response according to various embodiments of the present disclosure.

FIG. 9 illustrates a table that presents a comparison of an ACDV request with the corresponding DQS rule violations and the final ACDV response according to various embodiments of the present disclosure.

FIG. 10 illustrates a table that presents a comparison of an ACDV request with the corresponding DQS rule violations and the final ACDV response for a charge-off account according to various embodiments of the present disclosure.

FIG. 11 illustrates a table of protocol inaccuracies for three analysts and the resulting dispute quantity associated with these analysts according to various embodiments of the present disclosure.

FIG. 12 illustrates a table that presents a list of data quality rules related to credit reporting, along with their corresponding performance metrics according to various embodiments of the present disclosure.

FIGS. 13A-E are flow diagrams that illustrate a method for analyzing an object comprising data values for conformance of the values to parameter protocols and generating an error report for one or more identified inconsistencies in the data values according to various embodiments of the present disclosure.

FIG. 14 illustrates a general computer architecture that can be appropriately configured to implement components disclosed in accordance with various embodiments of the present disclosure.

Like reference numerals refer to like parts throughout the several views of the drawings.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. Digital object analysis and non-compliance reporting system and method thereof is discussed herein. In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention and is not intended to limit the invention to the specific embodiments illustrated by the figures or description below. The present invention will now be described by referencing the appended figures representing preferred embodiments.

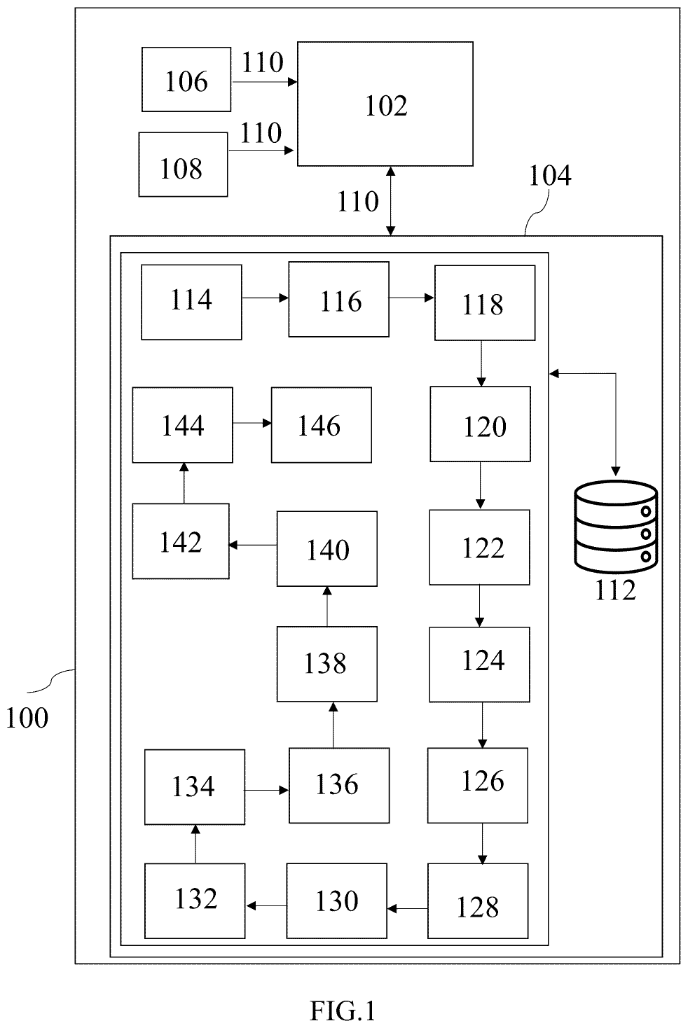

FIG. 1 illustrates a system for analyzing an object comprising data values for conformance of the values to parameter protocols and generating an error report for one or more identified inconsistencies in the data values according to various embodiments of the present disclosure.

The system 100 includes a computer 102, a server 104 coupled with the computer, a non-transitory, computer-readable medium communicably connected to the server 104, a first source 106, a second source 108, a communication network 110.

The server 104 includes a plurality of modules stored in a database 112 to analyze the object for conformance of values to parameter protocols and generate an error report for one or more identified inconsistencies in the data values. A first data receiving module 114 is configured to receive a first data set, of a first data set type, associated with the object. The first data set originates from the first source 106. A first data processing module 116 processes the first data set by applying a plurality of error detection algorithms to the first data set, incorporating additional rules based on regulatory guidance, court settlements, and client feedback to verify conformance of the values of the first data set to a first set of predefined parameter protocols. The parameter protocols include rules based on interdependencies between two or more values within the data set, for a specific month of data or across multiple months. A first nonconformance report generating module 118 is configured to identify and flag nonconformance of one or more of the values of the first data set relative to the first set of predefined parameter protocols and generates a first report indicating nonconformance within the first data set. A second data receiving module 120 is configured to receive a second data set, of a second data set type, associated with the object. The second data set originates from a second source 108, external to the first source 106. A second data reformatting and mapping module 122 is configured to reformat and map the data of the second data set associated with the object. The reformatting and mapping conform to the data formatting and mapping of the first data set. A second data processing module 124 processes the second data set by applying a plurality of error detection algorithms to the second data set to verify conformance of the values of the second data set to a second set of predefined parameter protocols based on interdependencies between two or more of the values within the second data set. A second nonconformance report generation module 126 is configured to identify and flag nonconformance of one or more of the values of the second data set relative to the second set of predefined parameter protocols and generates a second report indicating nonconformance within the second data set. A third data receiving module 128 is configured to receive a third data set, of a third data set type, associated with the object. The third data set originates from the first source 106 and received from the second source 108. A third data reformatting and mapping module 130 is configured to reformat and map the data of the third data set associated with the object. The reformatting and mapping conform to the data formatting and mapping of the first data set. A third data processing module 132 processes the third data set by applying a plurality of error detection algorithms to the third data set to verify conformance of the values of the third data set to a third set of predefined parameter protocols based on interdependencies between two or more of the values within the third data set. A third nonconformance report generation module 134 identifies and flags nonconformance of one or more of the values of the third data set relative to the second set of predefined parameter protocols and generates a third report indicating nonconformance within the third data set. A fourth data receiving module 136 is configured to possibly receive a fourth data set, of a fourth data set type, associated with the object. The fourth data set originates from the first source 106 and is received from the second source 108. A fourth data reformatting and mapping module 138 is configured to reformat and map the data of the fourth data set associated with the object, the reformatting and mapping conforming to the data formatting and mapping of the first data set. A fourth data processing module 140 processes the fourth data set by applying a plurality of error detection algorithms to the fourth data set to verify conformance of the values of the fourth data set to a fourth set of predefined parameter protocols based on interdependencies between two or more of the values within the fourth data set. A fourth nonconformance report generation module 142 identifies and flags nonconformance of one or more of the values of the fourth data set relative to the third set of predefined parameter protocols and generates a fourth report indicating nonconformance within the fourth data set. The computer receives additional data sets of any or all of the data set types, reformatting and mapping each data set from each respective data set type to conform to the data formatting and mapping of the first data set. The computer identifies and flags nonconformance of one or more of the values for each data set for each respective data set type and generates a report indicating nonconformance for each data set. A report analysis module 144 analyzes the reports from available data sets across all data set types to identify inconsistent data values within one or more of the first, second, third and fourth data set types and an error report generation module 146 generates an error report for one or more identified inconsistencies in the data values. The object may be a data set that changes over time and the system 100 may be used prior to reporting the object to a credit reporting agency, after a ACDV response and after a dispute resolution. The first data set comprises Metro 2® data originating from the first source 106. The data may come directly from the lender or furnisher, who provides the original credit information. Alternatively, it might be sourced from a technology vendor that manages data processing and reporting on behalf of the lender. In some cases, Metro 2 data could also be received by BDS (or similar entities) from a Consumer Reporting Agency (CRA), commonly referred to as credit bureaus, which act as intermediaries by supplying copies of the information they receive. This multi-channel flow of data helps ensure that credit information is accurately and consistently reported across the financial system.

The second data set comprises ACDV Request data originating from the second source 108. ACDV (Automated Credit Dispute Verification) request data primarily originates from Consumer Reporting Agencies (CRAs), which are responsible for managing credit information. This data can be received by BDS (or similar entities) through multiple channels. It may come directly from a CRA, ensuring the data reflects the information reported on consumer credit profiles. Alternatively, it can be received from Online Data Exchange, LLC (OLDE), the company that operates systems handling ACDV data, facilitating efficient dispute resolution processes. Additionally, ACDV request data can also be sourced from lenders or furnishers, who provide the underlying credit information that is subject to verification and disputes. This multi-source approach helps ensure the integrity and accuracy of the data used in resolving credit disputes.

The third data set comprises ACDV Response data originating from the first source 106 and received from the second source 108. It may be received by BDS from a CRA, OLDE, or a lender/furnisher. The fourth data set comprises AUD data originating from the first source 106 or a vendor providing technology services for a lender. It may be received by BDS from a CRA, OLDE, or a lender/furnisher.

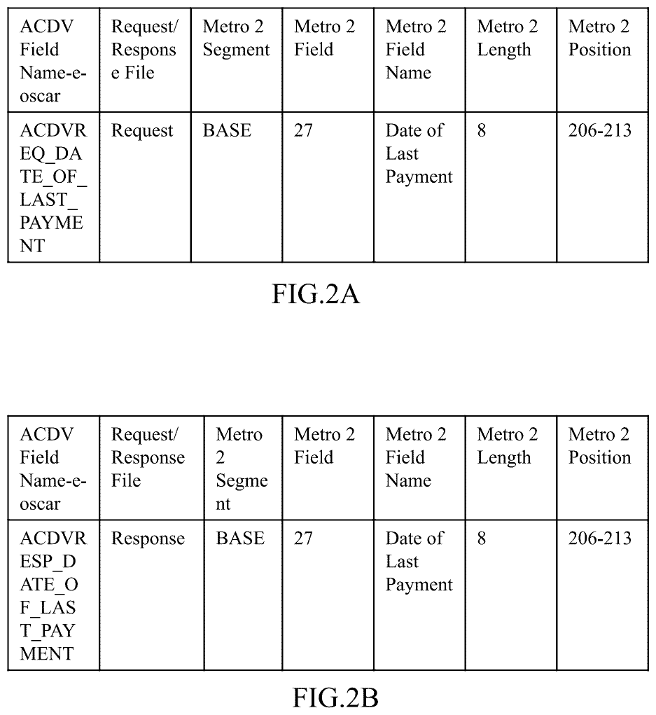

FIG. 2A-B illustrates a table that outlines the formatting rules and logic for the “Date of Last Payment” field during the ACDV process according to various embodiments of the present disclosure. The table 2A covers different scenarios, including when the date is missing or incomplete, and explains how to handle these cases when converting data to the Metro 2® format before and after the e-OSCAR 4.0 format change. ACDV Field Name-e-oscar: This column indicates the specific field being referenced in the ACDV process, which is “ACDVREQ_DATE_OF_LAST_PAYMENT” (i.e., the date of the last payment made on a financial account). Request/Response File: This identifies whether the data is part of the ACDV request (incoming data to be processed) or response (data sent back after processing). In this case, it's a “Request.” Metro 2 Segment: This column indicates the segment within the Metro 2® format where the field is located. Here, it is the “BASE” segment. Metro 2 Field: The field number in the Metro 2® format, which is “27” in this case. Metro 2 Field Name: The specific name of the field in the Metro 2® format, which is “Date of Last Payment.” Metro 2 Length: The length of the field in the Metro 2® format. The “Date of Last Payment” field has a length of 8 characters. Metro 2 Position: The position of the field within the Metro 2® format. For the “Date of Last Payment,” the position is from characters 206 to 213. Field Level Requirement (Prior to e-OSCAR 4.0 format change) includes details of how to handle the field data before the e-OSCAR 4.0 format change. The date must be formatted as MMDDYYYY (e.g., 02012022 for Feb. 1, 2022) with the time portion discarded. If the “Date of Last Payment” field is blank in the ACDV file, it should be filled with zeros in the Metro 2® request file. If a date value is present but without the day (e.g., only month and year provided like 072022), the system should use “01” as the day (e.g., 07302022 for July 2022). Additional Requirements and Notes includes the field's format that is “M/D/YYYY 0:00” and the logic used (called “waterfall logic”). According to Metro 2® guidelines, if the day is unavailable, it defaults to “01.” ACDV Files Format Changes Notes for e-OSCAR 4.0: This indicates that in the updated e-OSCAR 4.0 format, the date field now reports the date in the format “MM/DD/YYYY” and does not include the time.

The table 2B outlines how to handle the “Date of Last Payment” field in the Automated Credit Dispute Verification (ACDV) process for the response data, specifically in relation to the Metro 2® format. ACDV Field Name-e-oscar: The specific field being referenced in the ACDV process, which is “ACDVRESP_DATE_OF_LAST_PAYMENT” (i.e., the date of the last payment made on a financial account in the response). Request/Response File: Indicates whether the data is part of the ACDV request (incoming data to be processed) or response (data sent back after processing). In this case, it's a “Response.” Metro 2 Segment: Identifies the segment within the Metro 2® format where the field is located. Here, it is the “BASE” segment. Metro 2 Field: The field number in the Metro 2® format, which is “27” in this case. Metro 2 Field Name: The specific name of the field in the Metro 2® format, which is “Date of Last Payment.” Metro 2 Length: The length of the field in the Metro 2® format. The “Date of Last Payment” field has a length of 8 characters. Metro 2 Position: The position of the field within the Metro 2® format. For the “Date of Last Payment,” the position is from characters 206 to 213. Field Level Requirement (Prior to e-OSCAR 4.0 format change) includes details of how to handle the field data before the e-OSCAR 4.0 format change. The date must be formatted as MMDDYYYY (e.g., 02012022 for Feb. 1, 2022) with the time portion discarded. If the “ACDVRESP_DATE_OF_LAST_PAYMENT” field is blank, check if a value exists in the “ACDVREQ_DATE_OF_LAST_PAYMENT” field, and use that value. If no value exists, fill with zeros. If a valid date is present, it should be converted to MMDDYYYY format without the time part. If a date value is present but without the day (e.g., only month and year provided like 072022), the system should use “01” as the day (e.g., 07302022 for July 2022). If the date is entered as “1111 Nov. 11” followed by a time, it should be replaced with zeros in the Metro 2R response file, even if there is a value reported in the request field. Additional Requirements and Notes: The date field follows a “waterfall approach,” meaning there is a logical flow to how the date is handled based on available information. According to the Metro 2® guidelines, if the day is unavailable, it defaults to “01.” ACDV Files Format Changes Notes for e-OSCAR 4.0: This indicates that in the updated e-OSCAR 4.0 format, the date field now reports the date in the format “MM/DD/YYYY” and does not include the time.

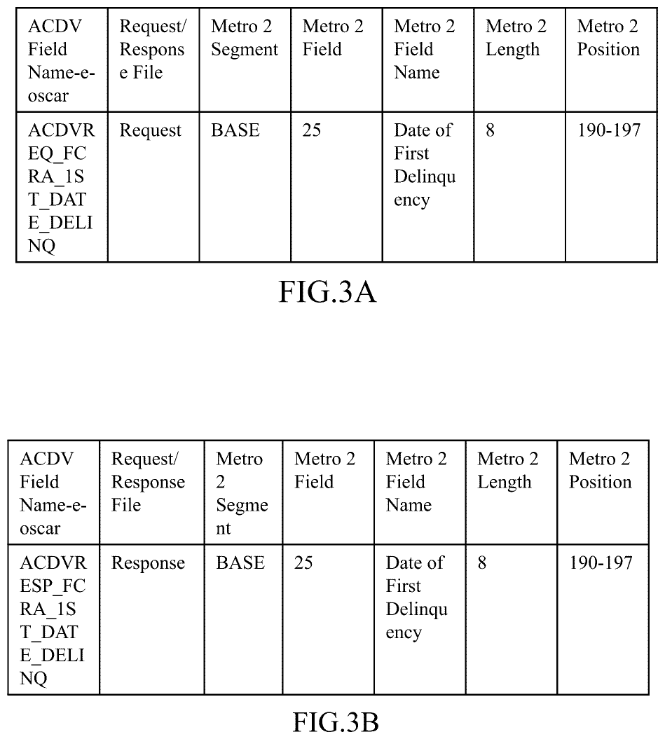

FIG. 3A-B illustrates tables focusing on handling the Date of First Delinquency in the context of ACDV requests and responses, and the corresponding updates for e-OSCAR format changes according to various embodiments of the present disclosure.

Table 3A details the processing and formatting logic for the “Date of First Delinquency” field in the ACDV Request File. The table outlines how the field is handled in different scenarios before and after the e-OSCAR 4.0 format update. ACDV Field Name-e-oscar: Specifies the field name in the e-OSCAR system, specifically in the ACDV request file. Request/Response File: Indicates that this is related to the request file in the ACDV process. Metro 2 Segment: Refers to the Metro 2 data segment being referenced, here, it's BASE. Metro 2 Field: The field number in the Metro 2 format, which is 25. Metro 2 Field Name: The corresponding field name in the Metro 2 format, which is “Date of First Delinquency.” Metro 2 Length: The length of the field in the Metro 2 format, which is 8 characters. Metro 2 Position: Specifies the position of the field in the Metro 2 file, located between positions 190 and 197. Field Level Requirement (Prior to e-OSCAR 4.0 format change): Describes the formatting and data population rules before the e-OSCAR 4.0 update. The date is provided with both date and time. It needs to be formatted as MMDDYYYY, with the time part removed. If the field is blank, it should be filled with zeros in the Metro 2 file. If the field contains a date, it is recorded in the Metro 2 file without the time part. If only the month and year are provided, the last day of the month is used for the day part. Additional Requirements and Notes includes additional logic related to the date format. The format of this field uses the date in the format M/D/YYYY 0:00. The waterfall logic applies here, where the last day of the month is assumed if the day part is missing. ACDV Files Format Changes Notes for e-OSCAR 4.0 describes the format change made with the e-OSCAR 4.0 update, where the date field is now reported in the MM/DD/YYYY format without the time component. The table 3A outlines how the Date of First Delinquency should be processed when making a request to a credit reporting agency. The key rules include discarding the time part, defaulting to the last day of the month when the day is missing, and filling zeros when the field is blank. The approach ensures compliance with Metro 2 formatting standards for accurate credit reporting.

Table 3B outlines the processing logic for the “Date of First Delinquency” field in the ACDV Response File. It describes the steps taken to correctly format and handle this date field based on specific conditions before and after the e-OSCAR 4.0 format change. ACDV Field Name-e-oscar: The field name in the e-OSCAR system, specifically for the ACDV response file. Request/Response File: Indicates that this logic applies to the response file in the ACDV process. Metro 2 Segment: Specifies the Metro 2 data segment being referenced, in this case, BASE. Metro 2 Field: Refers to the field number in the Metro 2 format, here identified as 25. Metro 2 Field Name: The corresponding field name in the Metro 2 format, which is “Date of First Delinquency.” Metro 2 Length: The length of the field in the Metro 2 format, which is 8 characters. Metro 2 Position: Specifies the position of the field in the Metro 2 file, located between positions 190 and 197. Field Level Requirement (Prior to e-OSCAR 4.0 format change) describes how the field should be formatted and filled before the e-OSCAR 4.0 update, including handling blank fields, missing day parts, and specific formats for different conditions. Additional Requirements and Notes provides further information on the format logic, such as using the 30th of the month if the day part is missing. ACDV Files Format Changes Notes for e-OSCAR 4.0 details the changes made to the ACDV file format with the transition to e-OSCAR 4.0, particularly the adoption of the MM/DD/YYYY format without time.

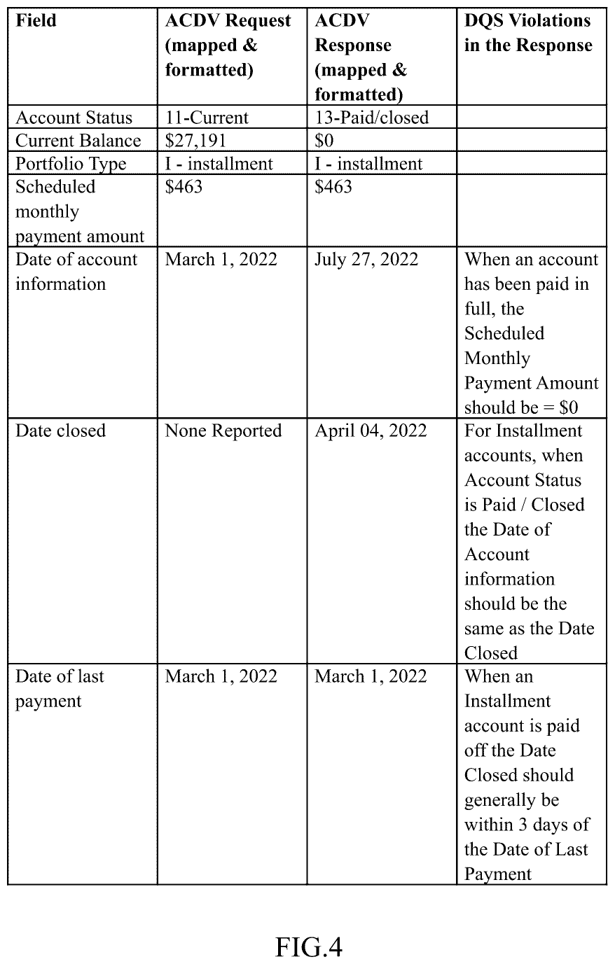

FIG. 4 illustrates a table that compares account information from an ACDV request to an ACDV response, highlighting discrepancies and potential data quality issues according to various embodiments of the present disclosure. As shown in FIG. 4, an ACDV request and ACDV response have values in the data set or object that do not match. Between the time of the ACDV request and the ACDV response, the current balance was paid off but the scheduled monthly payment amount was not removed. The DQS violation in the response is provided in the last column of the table. Specifically, when an account has been paid in full, the scheduled monthly payment amount should equal $0. Two other protocols are also listed. The system 100 may review each value for accuracy to a protocol and some values may be related as described for the scheduled monthly payment being related to the current balance. The system 100 may run specific algorithms wherein a particular value in the data set introduces a particular protocol for a second value. In this case, the zero balance results in a rule that the scheduled monthly payment should also be $0. The algorithm may have a plurality of if-then protocols between two or more values or value fields.

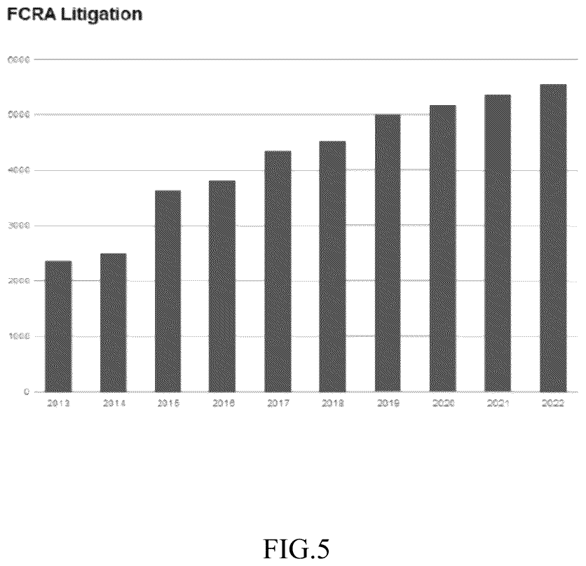

FIG. 5 illustrates a graph of FCRA litigation resulting from errors in financial data according to various embodiments of the present disclosure. The graph illustrates a significant increase in FCRA litigation cases between 2013 and 2022. The number of cases started at around 2,500 in 2013 and steadily climbed each year, reaching approximately 5,500 cases in 2022. This upward trend suggests a growing concern about Fair Credit Reporting Act violations during this period. The FCRA litigation has steadily increased for ten straight years.

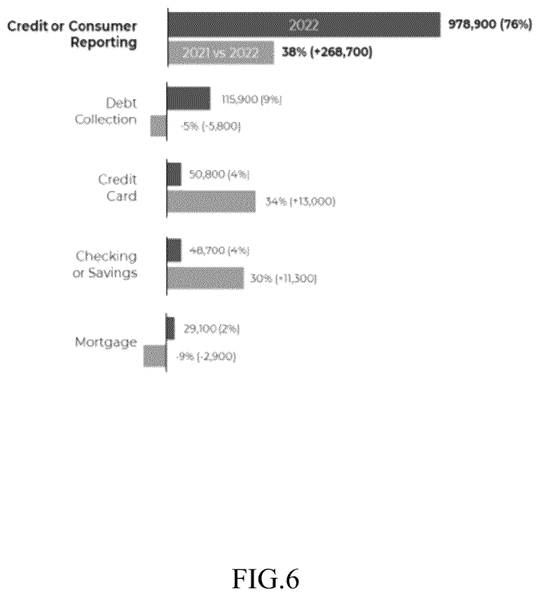

FIG. 6 illustrates a graph of complaint volume by category for complaints files with the Consumer Financial Protection Bureau (CFPB). The graph illustrates the number of credit or consumer reporting cases in 2022, and how that volume compared to all other major categories of complaints to the CFPB. The total number of complaints regarding consumer credit reporting was 978,900, with debt collection being the next most common category, accounting for 115,900 cases. The number of debt collection cases decreased by 5% from 2021 to 2022. Credit card cases were the third most common category, with 50,800 cases (4%), followed by checking or savings cases with 48,700 cases (4%). The number of credit card and checking or savings cases increased by 34% and 30%, respectively, from 2021 to 2022. Mortgage cases were the fifth most common category, with 29,100 cases (2%), and decreased by 9% from 2021 to 2022.

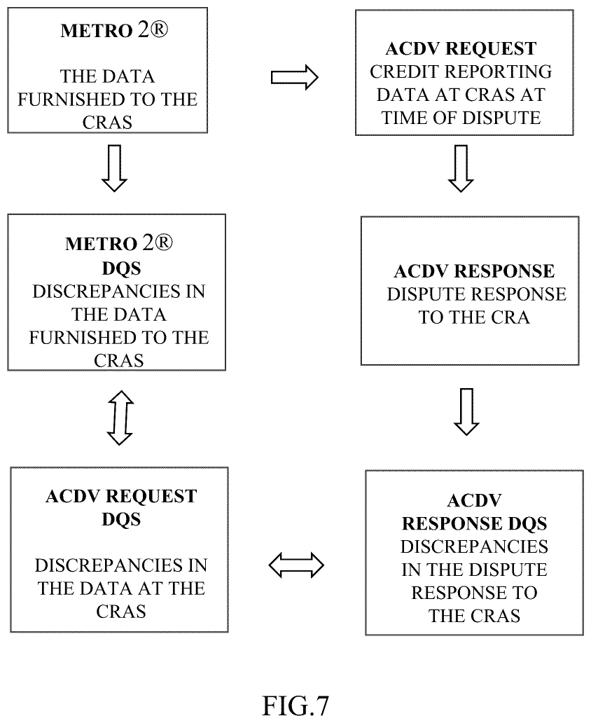

FIG. 7 illustrates an exemplary workflow of how the system of FIG. 1 may be utilized to reduce errors in the financial files according to various embodiments of the present disclosure. According to the workflow, initially, the data (e.g., first data set) is provided by a first source to a Credit Reporting Agency (CRA). The ACDV Request (e.g., second data set) is generated when a consumer disputes the credit reporting data. The ACDV Response (e.g., third data set) is generated when the lender investigates and responds to the dispute. Additionally, AUD form data (e.g., fourth data set) is generated from the first source or a vendor providing technology services for a lender. The data quality checks (DQS) are performed at each stage. The ACDV Request DQS analyzes discrepancies in the credit reporting data at the CRAs at the time of the dispute. The ACDV Response DQS includes comparing the dispute response to the original data furnished, evaluating which discrepancies at the CRAs were resolved in the response and identifying any new discrepancies created in the dispute response. Metro 2 DQS examines discrepancies between the original data furnished to CRAs and the data posted, identifies discrepancies resolved by the CRAs and pinpoints discrepancies caused by CRA transformations. The workflow aims to track data transformations between furnishing and posting, identify and address data discrepancies at various stages and ensure accurate and consistent credit reporting information.

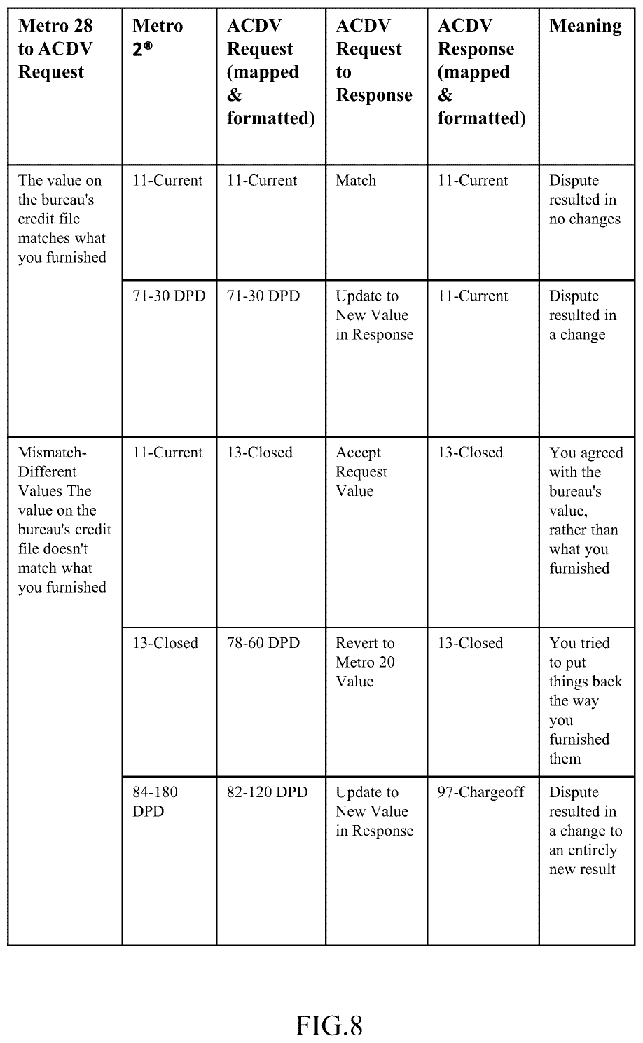

FIG. 8 illustrates a table presenting the values in the object being changed between a ACDV request and a ACDV response according to various embodiments of the present disclosure. The table outlines the potential outcomes of a credit dispute process, comparing data provided by the data furnisher to the information displayed on the credit bureau's file. Various actions can be taken, such as accepting the consumer's disputed value, reverting to the original furnished data, or updating the information to a new value. The table also indicates potential changes in account status, such as from current to closed or charged-off, based on the dispute resolution. The changes may be made as a function of the reporting from the system 100.

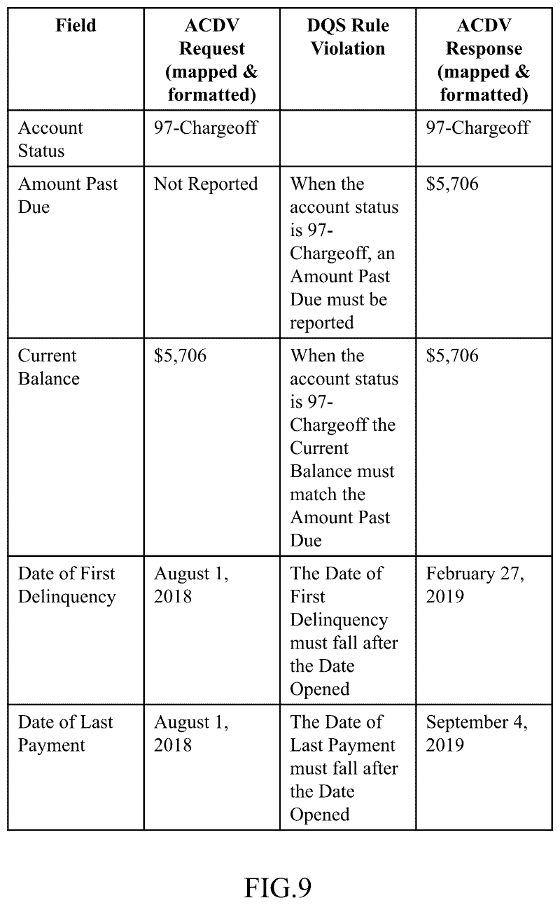

FIG. 9 illustrates a table that presents a comparison of an ACDV request with the corresponding DQS rule violations and the final ACDV response according to various embodiments of the present disclosure. The table shows how a particular value of the object was not accurate for a protocol and particular reporting on what the error was and how it should be resolved for accuracy. It focuses on an account with a charge-off status (97-Chargeoff). The ACDV request initially lacked an Amount Past Due, violating DQS rules, which were subsequently corrected in the ACDV response by reporting $5,706. Additionally, the Current Balance was adjusted to match the Amount Past Due as per DQS requirements. The Date Opened remained consistent throughout the process. However, the Date of First Delinquency and Date of Last Payment were corrected to align with DQS rules, falling after the Date Opened.

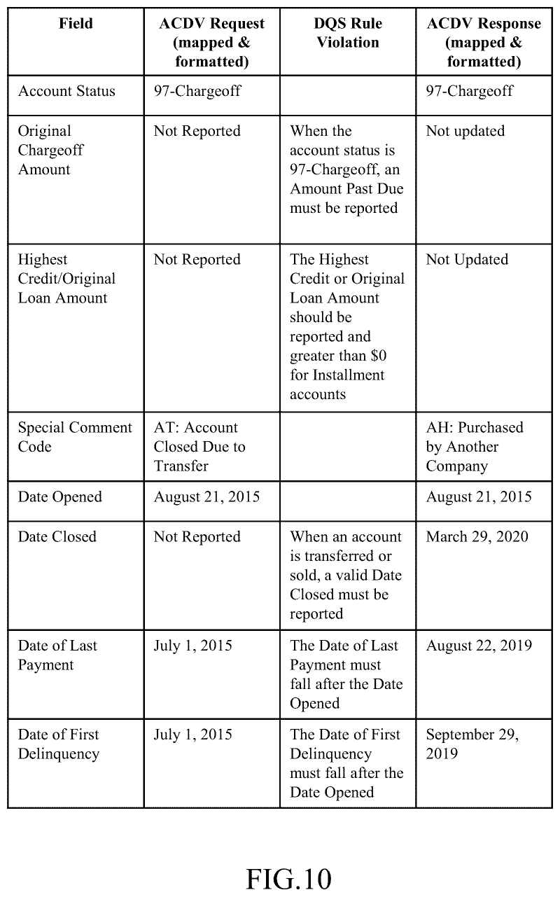

FIG. 10 illustrates a table that presents a comparison of an ACDV request with the corresponding DQS rule violations and the final ACDV response for a charge-off account according to various embodiments of the present disclosure. The ACDV request initially lacked several required fields, such as Original Chargeoff Amount, Highest Credit/Original Loan Amount, Date Closed, and accurate Date of Last Payment and Date of First Delinquency, violating DQS rules. The ACDV response corrected these discrepancies by providing missing information and ensuring that dates align appropriately. Additionally, the Special Comment Code was updated to reflect the account's transfer to another company.

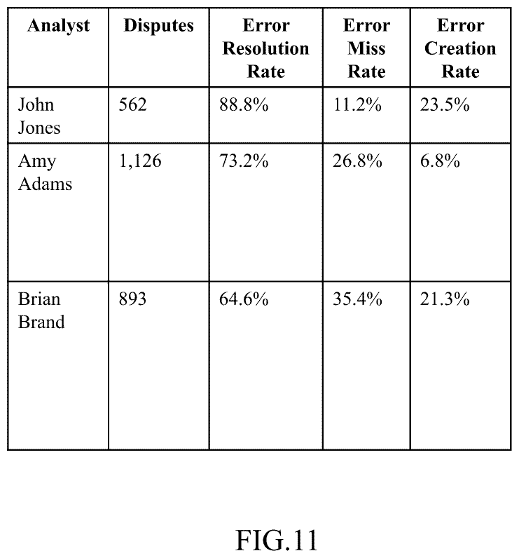

FIG. 11 illustrates a table of protocol inaccuracies for three analysts and the resulting dispute quantity associated with these analysts according to various embodiments of the present disclosure. The table provides performance metrics for three analysts handling disputes. It displays the number of disputes handled by each analyst, their error resolution rate (percentage of errors fixed), error miss rate (percentage of errors not fixed), and error creation rate (percentage of new errors introduced). Amy Adams has the highest number of disputes handled (1,126) and the highest error resolution rate (73.2%), while John Jones has the lowest error miss rate (11.2%) and Brian Brand has the lowest error creation rate (21.3%).

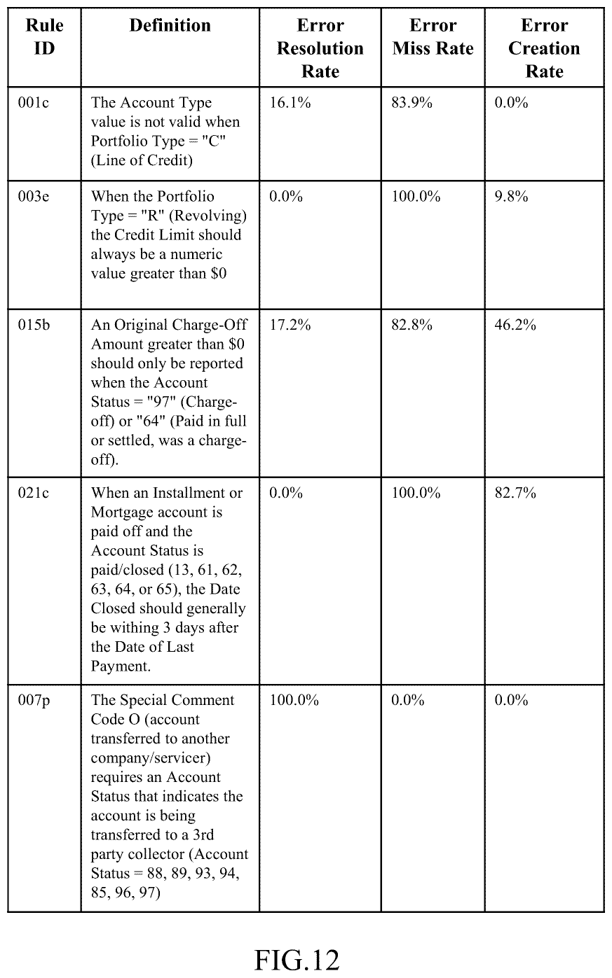

FIG. 12 illustrates a table that presents a list of data quality rules related to credit reporting, along with their corresponding performance metrics according to various embodiments of the present disclosure. The table protocol rules for specific values of an object or data set and the resulting error resolution rate, error miss rate and error creation rate. Rule 001c has a high error miss rate (83.9%) indicating that many violations of this rule go uncorrected. Rules 003e, 021c, and 007p have perfect error resolution rates (100%), meaning all detected errors were fixed. Rule 015b has a high error creation rate (46.2%), suggesting that fixing errors related to this rule often introduces new errors. The table provides insights into the effectiveness of data quality rules in identifying and correcting errors in credit reporting data.

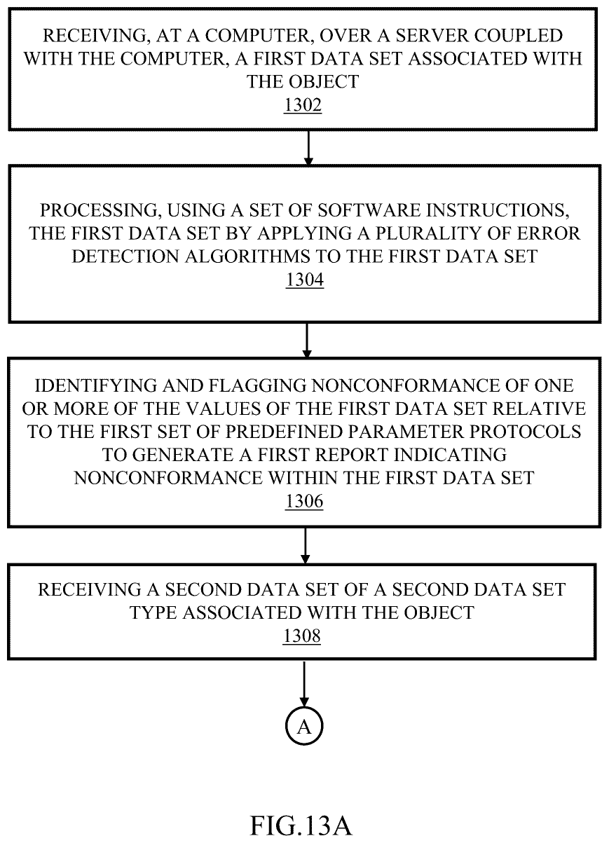

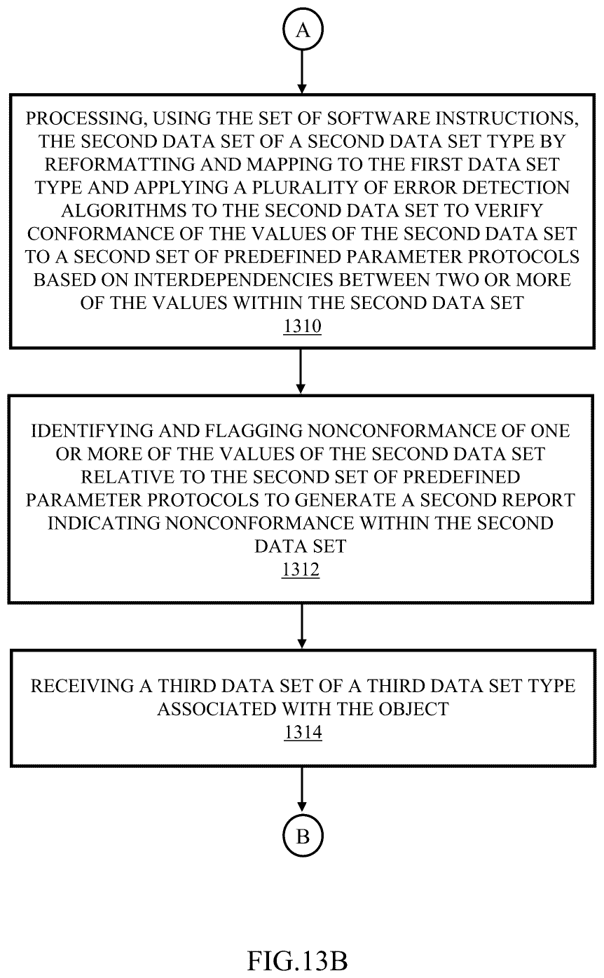

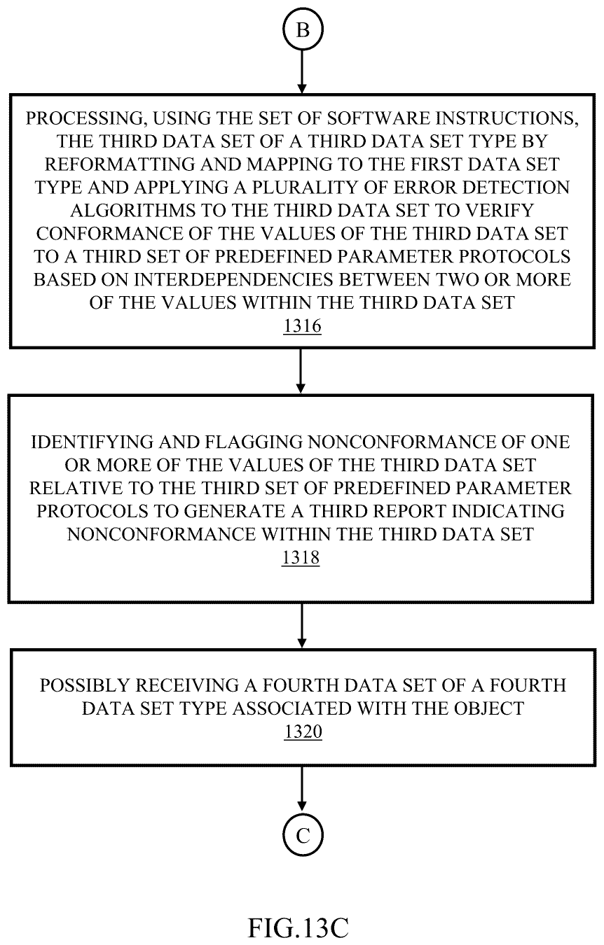

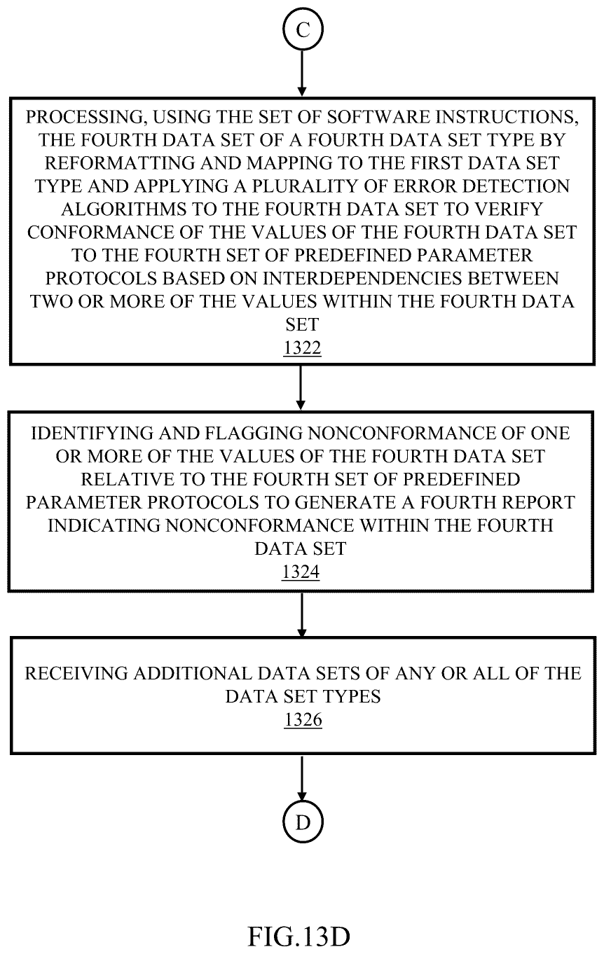

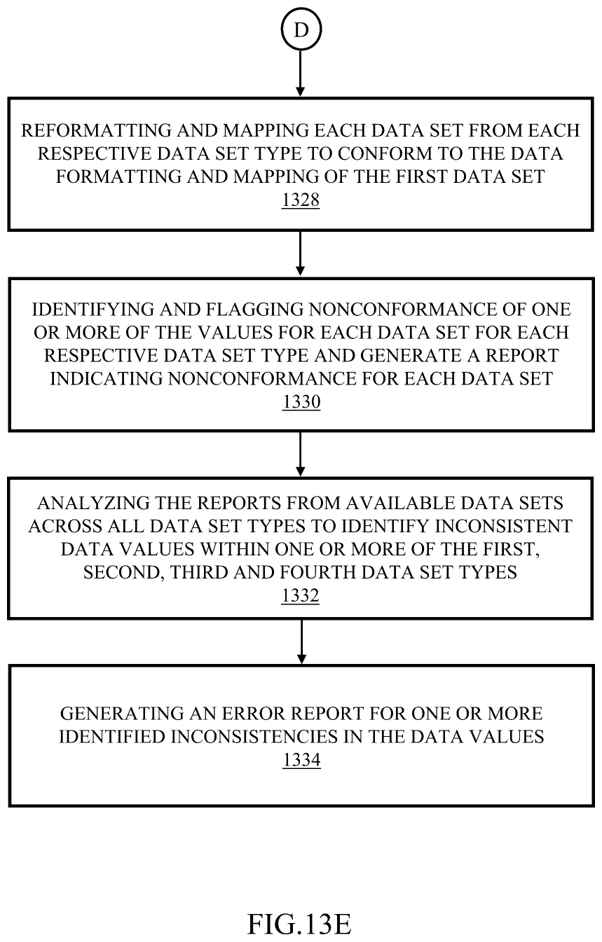

FIGS. 13A-E are flow diagrams that illustrate a method for analyzing an object comprising data values for conformance of the values to parameter protocols and generating an error report for one or more identified inconsistencies in the data values according to various embodiments of the present disclosure.

The method includes at step 1302, receiving, at a computer, over a server coupled with the computer, a first data set associated with the object. The first data set originates from a first source external to the computer.

The method includes at step 1304, processing, using a set of software instructions, the first data set by applying a plurality of error detection algorithms to the first data set, incorporating additional rules based on regulatory guidance, court settlements, and client feedback to verify conformance of the values of the first data set to a first set of predefined parameter protocols. The parameter protocols include rules based on interdependencies between two or more values within the data set, for a specific month of data or across multiple months.

The method includes at step 1306, identifying and flagging nonconformance of one or more of the values of the first data set relative to the first set of predefined parameter protocols to generate a first report indicating nonconformance within the first data set.

The method includes at step 1308, receiving a second data set of a second data set type associated with the object. The second data set type originates from a second source, external to the first source;

The method includes at step 1310, processing, using the set of software instructions, the second data set of a second data set type by reformatting and mapping to the first data set type and applying a plurality of error detection algorithms to the second data set to verify conformance of the values of the second data set to a second set of predefined parameter protocols based on interdependencies between two or more of the values within the second data set.

The method includes at step 1312, identifying and flagging nonconformance of one or more of the values of the second data set relative to the second set of predefined parameter protocols to generate a second report indicating nonconformance within the second data set.

The method includes at step 1314, receiving a third data set of a third data set type associated with the object. The third data set type originates from the first source and received from the second source.

The method includes at step 1316, processing, using the set of software instructions, the third data set of a third data set type by reformatting and mapping to the first data set type and applying a plurality of error detection algorithms to the third data set to verify conformance of the values of the third data set to a third set of predefined parameter protocols based on interdependencies between two or more of the values within the third data set.

The method includes at step 1318, identifying and flagging nonconformance of one or more of the values of the third data set relative to the third set of predefined parameter protocols to generate a third report indicating nonconformance within the third data set.

The method includes at step 1320, possibly receiving a fourth data set of a fourth data set type associated with the object. The fourth data set type originates from the first source and received from the second source.

The method includes at step 1322, processing, using the set of software instructions, the fourth data set of a fourth data set type by reformatting and mapping to the first data set type and applying a plurality of error detection algorithms to the fourth data set to verify conformance of the values of the fourth data set to the fourth set of predefined parameter protocols based on interdependencies between two or more of the values within the fourth data set.

The method includes at step 1324, identifying and flagging nonconformance of one or more of the values of the fourth data set relative to the fourth set of predefined parameter protocols to generate a fourth report indicating nonconformance within the fourth data set;

The method includes at step 1326, receiving additional data sets of any or all of the data set types.

The method includes at step 1328, reformatting and mapping each data set from each respective data set type to conform to the data formatting and mapping of the first data set.

The method includes at step 1328, identifying and flagging nonconformance of one or more of the values for each data set for each respective data set type and generating a report indicating nonconformance for each data set.

The method includes at step 1332, analyzing the reports from available data sets across all data set types to identify inconsistent data values within one or more of the first, second, third and fourth data set types.

The method includes at step 1334, generating an error report for one or more identified inconsistencies in the data values.

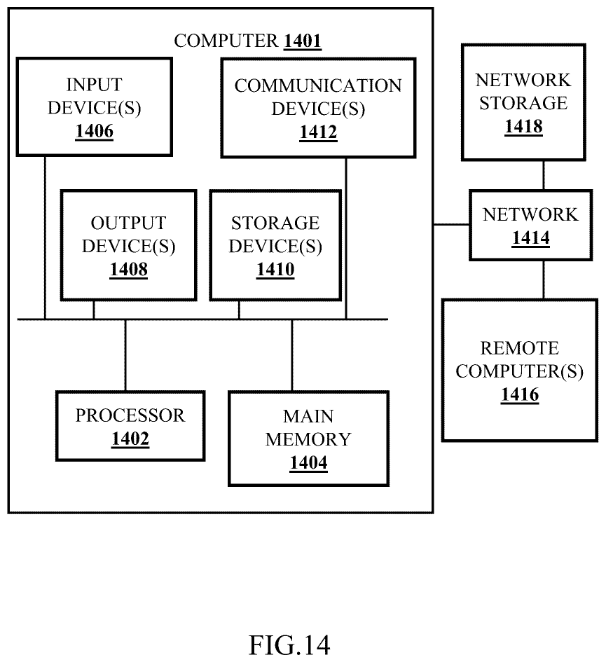

FIG. 14 illustrates a general computer architecture that can be appropriately configured to implement components disclosed in accordance with various embodiments of the present disclosure. The general computing architecture 1400 can include various common computing elements, such as a computer 1401, a network 1414, and one or more remote computers 1416. The computer 1401 may be a server, a desktop computer, a laptop computer, a tablet computer or a mobile computing device. The computer 1401 may include a processor 1402, a main memory 1404 and a system bus. The processor 1402 may feature one or more processing units that can operate independently of each other. The main memory 1404 may include volatile devices, non-volatile devices, or other random access memory devices. The computer 1401 may feature secondary storage 1410, consisting of one or more removable and/or non-removable storage units. These units house an operating system that manages various applications on the computer 1401. The secondary storage 1410 may also be used to store software configured to implement the components of the embodiments disclosed herein, which may be executed as one or more applications under the operating system. The computer 1401 may also include a communication device(s) 1412 through which the computer communicates with other devices, such as one or more remote computers 1416, over wired and/or wireless computer networks 1414. The communication device(s) 1412 may communicate over but not limited to Wi-Fi, Bluetooth, ultra-wide band technology, and mobile telephone networks. The computer 1401 may also access network storage 1418 through computer network 1414. The network storage 1418 may include a network-attached storage device or cloud-based storage. The operating system and/or software may be stored in network storage 1418. The computer 1401 may have various input device(s) 1406 for example, keyboard, mouse, touchscreen, camera, microphone, or a sensor, output device(s) 1408, for example, a display, speakers or a printer. Storage devices 1410, the communication device(s) 1412, input devices 1406 and output devices 1408 may be integrated within a computer system or connected through various computer input/output interface devices.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

What is claimed is:

1. A system for analyzing a database object comprising data values for conformance of the values to parameter protocols, and generating an error report for one or more identified inconsistencies in the data values, comprising:
a computer;
a server coupled with the computer; and
a non-transitory, computer-readable medium communicably connected to the server; and
storing instructions operable by said computer that, when executed by the server, cause the computer to:
receive a first data set, of a first data set type, associated with a database object, wherein the first data set originates from a first source external to the computer;
wherein the computer processes the first data set by applying a plurality of error detection algorithms to the first data set, incorporating additional rules based on regulatory guidance, court settlements, and client feedback to verify conformance of the data values of the first data set to a first set of predefined parameter protocols, wherein the parameter protocols include rules based on interdependencies between two or more of the data values within the data set, for a specific month of data or across multiple months;
identify and flag nonconformance of one or more of the data values of the first data set relative to the first set of predefined parameter protocols and generate a first report indicating nonconformance within the first data set;
receive a second data set, of a second data set type, associated with the object, wherein the second data set originates from a second source, external to the first source;
reformat and map the data of the second data set associated with the object, wherein the reformatting and mapping conform to the data formatting and mapping of the first data set;
wherein the computer processes the second data set by applying a plurality of error detection algorithms to the second data set to verify conformance of the data values of the second data set to a second set of predefined parameter protocols based on interdependencies between two or more of the data values within the second data set;
identify and flag nonconformance of one or more of the data values of the second data set relative to the second set of predefined parameter protocols and generate a second report indicating nonconformance within the second data set;
receive a third data set, of a third data set type, associated with the object, the third data set originating from the first source and received from the second source;
reformat and map the data of the third data set associated with the object, wherein the reformatting and mapping conform to the data formatting and mapping of the first data set;
wherein the computer processes the third data set by applying a plurality of error detection algorithms to the third data set to verify conformance of the data values of the third data set to a third set of predefined parameter protocols based on interdependencies between two or more of the data values within the third data set;
identify and flag nonconformance of one or more of the data values of the third data set relative to the second set of predefined parameter protocols and generate a third report indicating nonconformance within the third data set;
reformat and map each data set from each respective data set type to conform to the data formatting and mapping of the first data set;
identify and flag nonconformance of one or more of the data values for each data set for each respective data set type and generate a report indicating nonconformance for each data set;
analyze the reports from available data sets across all data set types to identify inconsistent data values within one or more of the data set types; and
generate an error report for one or more identified inconsistencies in the data values.

2. The system of claim 1, wherein the operability of the storing instructions to generate the error report for one or more identified inconsistencies in the data values is based on the instructions being operable by said computer that, when executed by the server, cause the computer to:
receive a fourth data set, of a fourth data set type, associated with the object, wherein the fourth data set originates from the first source and is received from the second source;
reformat and map the data of the fourth data set associated with the object, the reformatting and mapping conforming to the data formatting and mapping of the first data set;
wherein the computer processes the fourth data set by applying a plurality of error detection algorithms to the fourth data set to verify conformance of the data values of the fourth data set to a fourth set of predefined parameter protocols based on interdependencies between two or more of the data values within the fourth data set;
identify and flag nonconformance of one or more of the data values of the fourth data set relative to the third set of predefined parameter protocols and generate a fourth report indicating nonconformance within the fourth data set;
reformat and map each data set from each respective data set type to conform to the data formatting and mapping of the first data set;
identify and flag nonconformance of one or more of the data values for each data set for each respective data set type and generate a report indicating nonconformance for each data set;
analyze the reports from available data sets across all data set types to identify inconsistent data values within one or more of the data set types; and
generate an error report for one or more identified inconsistencies in the data values.

3. The system of claim 2, wherein the first data set comprises Metro 2® data originating from the first source, wherein the second data set comprises ACDV Request data originating from the second source, wherein the third data set comprises ACDV Response data originating from the first source and received from the second source, wherein the fourth data set comprises AUD data originating from the first source or a vendor providing technology services for a lender.

4. The system of claim 3, wherein the first source is a lender, a furnisher, or the vendor providing technology services for the lender, wherein the second source is a Consumer Reporting Agency (CRA), and external to the first source.

5. The system of claim 1, wherein the error detection algorithms comprise interdependent parameter protocols that trigger secondary checks based on the results of initial value verifications.

6. The system of claim 5, wherein the parameter protocol is applied for the value when another value meets a threshold parameter protocol.

7. The system of claim 1, wherein the computer provides detailed error descriptions for identified nonconformances and inconsistencies.

8. The system of claim 1, wherein the computer provides corrective action recommendations for select identified nonconformances and inconsistencies.

9. The system of claim 1, wherein the object comprises financial data related to a specific consumer account.

10. The system of claim 2, wherein the second data set type, the third data set type, and the fourth data set type are formatted according to a standardized ASCII Metro 2® format.

11. An automated computer database method for analyzing a database object comprising data values for conformance of the values to parameter protocols, and generating an error report for one or more identified inconsistencies in the data values, comprising:
receiving, at a computer, over a server coupled with the computer, a first data set associated with a database object, wherein the first data set originates from a first source external to the computer;
processing, using a set of software instructions, the first data set by applying a plurality of error detection algorithms to the first data set, incorporating additional rules based on regulatory guidance, court settlements, and client feedback to verify conformance of the values of the first data set to a first set of predefined parameter protocols, wherein the parameter protocols include rules based on interdependencies between two or more values within the data set, for a specific month of data or across multiple months;
identifying and flagging nonconformance of one or more of the values of the first data set relative to the first set of predefined parameter protocols to generate a first report indicating nonconformance within the first data set;
receiving a second data set of a second data set type associated with the object, wherein the second data set type originates from a second source, external to the first source;
processing, using the set of software instructions, the second data set of a second data set type by reformatting and mapping to the first data set type and applying a plurality of error detection algorithms to the second data set to verify conformance of the values of the second data set to a second set of predefined parameter protocols based on interdependencies between two or more of the values within the second data set;
identifying and flagging nonconformance of one or more of the values of the second data set relative to the second set of predefined parameter protocols to generate a second report indicating nonconformance within the second data set;
receiving a third data set of a third data set type associated with the object, wherein the third data set type originates from the first source and received from the second source;
processing, using the set of software instructions, the third data set of a third data set type by reformatting and mapping to the first data set type and applying a plurality of error detection algorithms to the third data set to verify conformance of the values of the third data set to a third set of predefined parameter protocols based on interdependencies between two or more of the values within the third data set;
identifying and flagging nonconformance of one or more of the values of the third data set relative to the third set of predefined parameter protocols to generate a third report indicating nonconformance within the third data set;
reformatting and mapping each data set from each respective data set type to conform to the data formatting and mapping of the first data set;
identifying and flagging nonconformance of one or more of the values for each data set for each respective data set type and generating a report indicating nonconformance for each data set;
analyzing the reports from available data sets across all data set types to identify inconsistent data values within one or more of the data set types; and
generating an error report for one or more identified inconsistencies in the data values.

12. The method of claim 11, wherein the method further includes:
receiving a fourth data set of a fourth data set type associated with the object, wherein the fourth data set type originates from the first source and received from the second source;
processing, using the set of software instructions, the fourth data set of a fourth data set type by reformatting and mapping to the first data set type and applying a plurality of error detection algorithms to the fourth data set to verify conformance of the values of the fourth data set to a fourth set of predefined parameter protocols based on interdependencies between two or more of the values within the fourth data set;
identifying and flagging nonconformance of one or more of the values of the fourth data set relative to the fourth set of predefined parameter protocols to generate a fourth report indicating nonconformance within the fourth data set;
reformatting and mapping each data set from each respective data set type to conform to the data formatting and mapping of the first data set;
identifying and flagging nonconformance of one or more of the values for each data set for each respective data set type and generating a report indicating nonconformance for each data set;
analyzing the reports from available data sets across all data set types to identify inconsistent data values within one or more of the data set types; and
generating an error report for one or more identified inconsistencies in the data values.

13. The method of claim 12, wherein the first data set comprises Metro 2® data originating from the first source, wherein the second data set comprises ACDV Request data originating from the second source, wherein the third data set comprises ACDV Response data originating from the first source and received from the second source, wherein the fourth data set comprises AUD data originating from the first source or a vendor providing technology services for a lender.

14. The method of claim 11, wherein the first source is a lender, a furnisher, or a vendor providing technology services for the lender, wherein the second source is a Consumer Reporting Agency (CRA), and external to the first source.

15. The method of claim 11, wherein the error detection algorithms comprise interdependent parameter protocols that trigger secondary checks based on the results of initial value verifications.

16. The method of claim 15, wherein the parameter protocol is applied for the value when another value meets a threshold parameter protocol.

17. The method of claim 11, wherein the method includes providing detailed error descriptions for identified nonconformances and inconsistencies.

18. The method of claim 11, wherein the method includes providing corrective action recommendations for select identified nonconformances and inconsistencies.

19. The method of claim 11, wherein the object comprises financial data related to a specific consumer account.

20. A non-transitory computer-readable storage medium in a system for analyzing an object comprising data values for conformance of the values to parameter protocols, and generating an error report for one or more identified inconsistencies in the data values, the computer-readable storage medium storing programming instructions that, if executed by a server of the system, are operable to cause the system to perform operations comprising:
receiving, at a computer, over a server coupled with the computer, a first data set associated with the object, wherein the first data set originates from a first source external to the computer;
processing, using a set of software instructions, the first data set by applying a plurality of error detection algorithms to the first data set, incorporating additional rules based on regulatory guidance, court settlements, and client feedback to verify conformance of the values of the first data set to a first set of predefined parameter protocols, wherein the parameter protocols include rules based on interdependencies between two or more values within the data set, for a specific month of data or across multiple months;
identifying and flagging nonconformance of one or more of the values of the first data set relative to the first set of predefined parameter protocols to generate a first report indicating nonconformance within the first data set;
receiving a second data set of a second data set type associated with the object, wherein the second data set type originates from a second source, external to the first source;
processing, using the set of software instructions, the second data set of a second data set type by reformatting and mapping to the first data set type and applying a plurality of error detection algorithms to the second data set to verify conformance of the values of the second data set to a second set of predefined parameter protocols based on interdependencies between two or more of the values within the second data set;
identifying and flagging nonconformance of one or more of the values of the second data set relative to the second set of predefined parameter protocols to generate a second report indicating nonconformance within the second data set;
receiving a third data set of a third data set type associated with the object, wherein the third data set type originates from the first source and received from the second source;
processing, using the set of software instructions, the third data set of a third data set type by reformatting and mapping to the first data set type and applying a plurality of error detection algorithms to the third data set to verify conformance of the values of the third data set to a third set of predefined parameter protocols based on interdependencies between two or more of the values within the third data set;
identifying and flagging nonconformance of one or more of the values of the third data set relative to the third set of predefined parameter protocols to generate a third report indicating nonconformance within the third data set;
receiving a fourth data set of a fourth data set type associated with the object, wherein the fourth data set type originates from the first source and received from the second source;
processing, using the set of software instructions, the fourth data set of a fourth data set type by reformatting and mapping to the first data set type and applying a plurality of error detection algorithms to the fourth data set to verify conformance of the values of the fourth data set to the fourth set of predefined parameter protocols based on interdependencies between two or more of the values within the fourth data set;
identifying and flagging nonconformance of one or more of the values of the fourth data set relative to the fourth set of predefined parameter protocols to generate a fourth report indicating nonconformance within the fourth data set;
receiving additional data sets of any or all of the data set types;
reformatting and mapping each data set from each respective data set type to conform to the data formatting and mapping of the first data set;
identifying and flagging nonconformance of one or more of the values for each data set for each respective data set type and generate a report indicating nonconformance for each data set;
analyzing the reports from available data sets across all data set types to identify inconsistent data values within one or more of the first, second, third and fourth data set types; and
generating an error report for one or more identified inconsistencies in the data values.
